(19) United States
(12) Patent Application Publication
(10) Pub. No.: US 2004/0155530 A1
(43) Pub. Date: Aug. 12, 2004

(54) Frequency regulating circuit

(76) Inventors: Holger Sedlak, Sauerlach (DE); Oliver Kniffler, Munchen (DE); Uwe Weder, AU/Hallertau (DE); Shuwei Guo, Beijing (CN)

Correspondence Address: LERNER AND GREENBERG, P.A., POST OFFICE BOX 2480, HOLLYWOOD, FL, 33022-2480, US

(21) Appl. No.: 10/701,058

(22) Filed: Nov. 4, 2003

Related U.S. Application Data
(63) Continuation of application No. PCT/DE02/01283, filed on Apr. 8, 2002.

(30) Foreign Application Priority Data
May 4, 2001 (DE) 101 21 821.4

(51) Int. Cl. H02B 1/24; H02H 3/08

(52) U.S. Cl. 307/131

(57) ABSTRACT

A frequency regulating circuit for the current-consumption-dependent clock supply of a circuit configuration includes a current measuring device for measuring the instantaneous current consumption of the circuit configuration, a controllable clock supply circuit, which can be connected to a clock input of the circuit configuration, and a control device for driving the clock supply circuit based upon the measured current consumption, an increase in the current consumption of the circuit configuration effecting a reduction in the clock frequency at the output of the clock supply circuit. Such a circuit ensures that a maximum permissible current consumption is not exceeded, but, at the same time, makes possible a maximum power of the circuit by a maximum clock frequency.

### CROSS-REFERENCE TO RELATED APPLICATION

This application is a continuation of copending International Application No. PCT/DE02/01283, filed Apr. 8, 2002, which designated the United States and was not published in English.

### BACKGROUND OF THE INVENTION

Field of the Invention

The invention relates to a frequency regulating circuit for circuit configurations.

In circuit configurations, the current consumption often depends on what functions are currently being executed by the circuit configuration. In digital circuits, for example, significantly more current is required for a multiplication than for a simple addition. It should be taken into consideration here that a high current consumption results in heating of the digital circuit and care must, therefore, be taken to ensure that the circuit configuration does not become too hot when carrying out specific functions. Moreover, the current consumption is proportional to the clock frequency with which the circuit configuration operates. The higher the clock frequency, the higher, of course, the current consumption, too.

To avoid excessively great heating of the circuit configuration, it is known, therefore, to determine the function of the circuit configuration with the highest current consumption and, then, to ascertain, when these functions are being carried out, that frequency at which the current consumption does not exceed the permissible maximum value. The frequency thus determined is, then, specified as maximum operating frequency of the circuit configuration. In the case of other functions of the circuit configuration, however, a higher frequency and, thus, overall, a better power behavior would be possible, without the maximum allowed current consumption being exceeded in the process.

### SUMMARY OF THE INVENTION

It is accordingly an object of the invention to provide a frequency regulating circuit that overcomes the hereinafore-mentioned disadvantages of the heretofore-known devices of this general type and that enables a highest possible power of the circuit configuration by utilizing the maximum possible frequency, without the circuit configuration being heated to an impermissibly great extent in the process.

With the objects of the invention in view, there is also provided a frequency regulating circuit for the current-consumption-dependent clock supply of a circuit configuration, including a current measuring device for measuring an instantaneous current consumption of the circuit configuration, a controllable clock supply circuit having an output to be connected to a clock input of the circuit configuration and a clock generator generating a clock signal with clock pulses at the output, and a control device connected to the clock supply circuit and driving the clock supply circuit based upon the measured current consumption, the control device controlling the clock supply circuit to filter out individual clock pulses of the clock signal and reduce a clock frequency at the output of the clock supply circuit when the current consumption of the circuit configuration increases.

With the objects of the invention in view, there is also provided a frequency regulating circuit for the current-consumption-dependent clock supply of a circuit configuration, including a current measuring device for measuring an instantaneous current consumption of the circuit configuration, a controllable clock supply circuit having an output to be connected to a clock input of the circuit configuration and a clock generator generating a clock signal with clock pulses at the output, and a control device connected to the clock supply circuit and driving the clock supply circuit based upon the measured current consumption, the control device programmed to control the clock supply circuit by filtering out individual clock pulses of the clock signal to reduce a clock frequency at the output of the clock supply circuit when the current consumption of the circuit configuration increases.

With the objects of the invention in view, there is also provided a frequency regulating circuit for the current-consumption-dependent clock supply of a circuit configuration, including a current measuring device for measuring an instantaneous current consumption of the circuit configuration, a controllable clock supply circuit having an output to be connected to a clock input of the circuit configuration and a clock generator generating a clock signal with clock pulses at the output, and a control device connected to the clock supply circuit and driving the clock supply circuit based upon the measured current consumption, the control device programmed to filter out individual clock pulses of the clock signal for reducing a clock frequency at the output of the clock supply circuit during an increase in the current consumption of the circuit configuration.

The circuit, thus, measures the instantaneous current consumption and, based upon the latter, controls the frequency of the clock signal with which the circuit configuration is supplied. This ensures that the circuit configuration always operates with the maximum power that is possible taking account of the permissible maximum values for the current consumption. Thus, the maximum possible power is always available, without the circuit configuration being endangered by excessively great heating.

In an advantageous refinement of the clock supply circuit, the clock supply circuit has a clock generator that provides a clock signal with a constant frequency. A pulse filter is connected to the clock generator, which pulse filter can be driven by the control device. To reduce the clock frequency to be output to the circuit configuration, the pulse filter filters out or suppresses individual pulses from the clock signal made available by the clock generator.

In accordance with a concomitant feature of the invention, a comparator compares the current measured by the current measuring device with a definable threshold value.

Other features that are considered as characteristic for the invention are set forth in the appended claims.

Although the invention is illustrated and described herein as embodied in a frequency regulating circuit, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a frequency regulating circuit according to the invention; and

FIG. 2 is a block circuit diagram of a portion of the clock supply circuit of FIG. 1.

### DESCRIPTION OF THE PREFERRED EMBODIMENTS

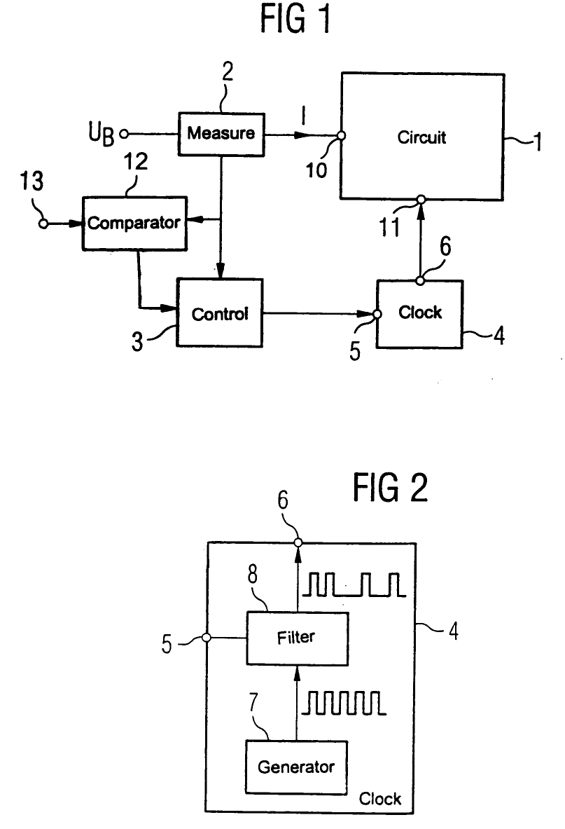

Referring now to the figures of the drawings in detail and first, particularly to FIG. 1 thereof, there is shown a frequency regulating circuit according to the invention. The circuit configuration 1 has a voltage supply input 10 and a clock input 11. The voltage supply input 10 is connected to an operating voltage U_{B}. A current I taken up by the circuit configuration 1 is measured by a current measuring device 2. A control device 3 converts the measurement result of the current measuring device 2 into a control signal for a clock supply circuit 4. To that end, the control device is connected to a control input 5 of the clock supply circuit 4. A clock output 6 of the clock supply circuit 4 is, in turn, connected to the clock input 11 of the circuit configuration 1.

When computational operations that have a high current demand are carried out in the circuit configuration 1, the demand is detected by the current measuring device 2 and, provided that this results in exceeding the maximum permissible current, the control device 3 drives the clock supply circuit 4 such that the clock frequency made available to the circuit configuration 1 is reduced. By virtue of the reduction in the clock frequency with which the circuit configuration 1 operates, the current consumption thereof also decreases, which decrease the measuring device 2 detects. On account of this, the clock frequency provided by the clock circuit 4 is increased again so that, at any time, a maximum possible clock frequency is made available.

A more detailed illustration of the clock supply circuit is illustrated in FIG. 2. Accordingly, the clock supply circuit has a clock generator 7, which generates a constant maximum internal frequency. Moreover, it has a pulse filter 8, which is connected to the control input 5 and the clock output 6. To reduce the clock frequency, as described with reference to FIG. 1, individual pulses of the clock signal generated by the clock generator 7 are suppressed, which leads overall to a reduction in the clock frequency.

A comparator 12 can be connected to the output of the current measuring device 2 to compare the current measured by the current measuring device 2 with a definable threshold value 13.

We claim:

1. A frequency regulating circuit for the current-consumption-dependent clock supply of a circuit configuration, comprising:
a current measuring device for measuring an instantaneous current consumption of the circuit configuration;
a controllable clock supply circuit having:
an output to be connected to a clock input of the circuit configuration; and
a clock generator generating a clock signal with clock pulses at said output; and
a control device connected to said clock supply circuit and driving said clock supply circuit based upon the measured current consumption, said control device controlling said clock supply circuit to filter out individual clock pulses of said clock signal and reduce a clock frequency at said output of said clock supply circuit when the current consumption of the circuit configuration increases.

2. The frequency regulating circuit according to claim 1, further comprising means for comparing the current measured by the current measuring device with a definable threshold value.

3. The frequency regulating circuit according to claim 1, further comprising a comparator comparing the current measured by the current measuring device with a definable threshold value.

4. A frequency regulating circuit for the current-consumption-dependent clock supply of a circuit configuration, comprising:
a current measuring device for measuring an instantaneous current consumption of the circuit configuration;
a controllable clock supply circuit having:
an output to be connected to a clock input of the circuit configuration; and
a clock generator generating a clock signal with clock pulses at said output; and
a control device connected to said clock supply circuit and driving said clock supply circuit based upon the measured current consumption, said control device programmed to control said clock supply circuit by filtering out individual clock pulses of said clock signal to reduce a clock frequency at said output of said clock supply circuit when the current consumption of the circuit configuration increases.

5. The frequency regulating circuit according to claim 4, further comprising means for comparing the current measured by the current measuring device with a definable threshold value.

6. The frequency regulating circuit according to claim 4, further comprising a comparator comparing the current measured by the current measuring device with a definable threshold value.

7. A frequency regulating circuit for the current-consumption-dependent clock supply of a circuit configuration, comprising:
a current measuring device for measuring an instantaneous current consumption of the circuit configuration;
a controllable clock supply circuit having:
an output to be connected to a clock input of the circuit configuration; and
a clock generator generating a clock signal with clock pulses at said output; and
a control device connected to said clock supply circuit and driving said clock supply circuit based upon the measured current consumption, said control device programmed to filter out individual clock pulses of said clock signal for reducing a clock frequency at said output of said clock supply circuit during an increase in the current consumption of the circuit configuration.

8. The frequency regulating circuit according to claim 7, further comprising means for comparing the current measured by the current measuring device with a definable threshold value.

9. The frequency regulating circuit according to claim 7, further comprising a comparator comparing the current measured by the current measuring device with a definable threshold value.
